(19) United States
(12) Patent Application Publication
(10) Pub. No.: US 2013/0118962 A1
(43) Pub. Date: May 16, 2013

(54) Systems For Processing Abrasive Slurry

(71) Applicant: MEMC ELECTRONIC MATERIALS, INC., St. Peters, MO (US)

(72) Inventors: Henry F. Erk, St. Louis, MO (US); Vandan Tanna, Dardenne Prairie, MO (US)

(73) Assignee: MEMC ELECTRONIC MATERIALS, INC., St. Peters, MO (US)

(21) Appl. No.: 13/733,499

(22) Filed: Jan. 3, 2013

Related U.S. Application Data
(62) Division of application No. 12/840,549, filed on Jul. 21, 2010.
(60) Provisional application No. 61/228,728, filed on Jul. 27, 2009.

(51) Int. Cl. B01D 21/28

(52) U.S. Cl. CPC B01D 21/283
USPC 210/137; 210/532.1

(57) ABSTRACT

Systems and methods are provided for processing abrasive slurry used in cutting operations. The slurry is mixed with a first solvent in a tank. The slurry is vibrated and/or ultrasonically agitated such that abrasive grain contained in the slurry separates from the other components of the slurry and the first solvent. After the abrasive grain has settled to a bottom portion of the container, the other components of the slurry and the first solvent are removed from the tank. The abrasive grain may then be washed with a second solvent. The abrasive grain is then heated and is suitable for reuse in an abrasive slurry.

### CROSS-REFERENCE TO RELATED APPLICATIONS

This application is a divisional of U.S. patent application Ser. No. 12/840,549, filed on Jul. 21, 2010, which claims the benefit of U.S. Provisional Patent Application No. 61/228,728, filed Jul. 27, 2009, the entire disclosures of which are incorporated herein by reference.

### BACKGROUND

The field of the disclosure relates generally to the processing of abrasive slurry, and more specifically to the processing of abrasive slurry used in a wire saw for slicing a wafer from an ingot, such as an ingot.

Wafers used for semiconductors and solar cells are typically cut with a wire saw from an ingot made of silicon, germanium or the like. The wire saw cuts the silicon ingot by contacting the ingot with a wire covered in abrasive slurry. The abrasive slurry is typically comprised of a fine abrasive, such as silicon carbide (SiC) or an industrial diamond suspended in a liquid suspension medium. Two types of liquid suspension media are often used: polyethylene glycol or an oil (e.g., a mineral, vegetable, or petroleum-based oil) with an additive such as hydrated clay or bentonite. Glycol-based slurries typically are more easily diluted with water than oil-based slurries. Oil-based slurries have the added benefit of more uniformly suspending the abrasive therein when compared to glycol-based slurries. Moreover, oil-based slurries have better lubrication properties and require less force to be exerted on the wire to slice the silicon ingot than the force required for glycol-based slurries.

In operation, the silicon ingot is cut by applying force to the wire to press the wire against the ingot. The abrasive slurry is drawn in between the wire and the silicon ingot and thereby abrades the ingot and removes fine silicon particles from the ingot. The fine silicon particles are carried away from the interface of the wire and the silicon ingot by the abrasive slurry and are mixed therewith.

Over time, the fine silicon particles and small particles of wire dilute the abrasive contained in the slurry and thus reduce the effectiveness of the wire saw. The slurry becomes ineffective and/or exhausted and the efficiency of the wire saw is greatly reduced. Accordingly, the silicon fines and wire particles must occasionally be separated from the slurry or the slurry replaced altogether in order to maintain the efficiency of the cutting operation.

The degree of difficulty in separating the silicon fines and wire particles from the slurry is largely dependent on the composition of the liquid suspension medium. In glycol-based slurries, separation of the silicon fines and wire particles from the remainder of the slurry is accomplished through mechanical and chemical processes. Oil-based slurries are not easily separable by mechanical processes. Water is not an acceptable solvent since generally an emulsion is formed with the addition of water. Strong solvents and/or chemicals are required to separate oil-based slurries. These strong solvents and/or chemicals pose health and environmental hazards and significant expense is incurred in their proper handling and disposal.

### BRIEF SUMMARY

A first aspect is a method for recovering abrasive grain from slurry. The method comprises diluting the slurry with a first amount of a solvent in a container, wherein the slurry includes at least a liquid suspension medium and the abrasive grain. The slurry and the first amount of the solvent are then vibrated. At least some of the abrasive grain is allowed to settle to a bottom portion of the container. Substantially all of a first remaining liquid suspension is removed from the container. The settled abrasive grain is then heated.

Another aspect is a method for recovering abrasive grain from slurry. The method comprises diluting the slurry with a first amount of a solvent in a tank, wherein the slurry includes at least a liquid suspension medium and the abrasive grain. The slurry and the first amount of the solvent are then vibrated. Substantially all of a first remaining liquid suspension is removed after at least half of the abrasive grain has settled to a bottom portion of the tank. A second amount of solvent is added to the tank and the settled abrasive grain contained therein. The slurry and the second amount of the solvent are then vibrated. Substantially all of a second remaining liquid suspension is removed after at least half of the abrasive grain has settled to the bottom portion of the tank.

Another aspect is a method of recovering an abrasive from a wire slicing abrasive slurry. The method comprises diluting the wire slicing abrasive slurry with a first amount of a solvent in a tank, wherein the wire slicing slurry includes at least an oil-based liquid suspension medium and an abrasive grain. The wire slicing slurry and the first amount of the solvent are then vibrated for a first predetermined period of time. A first amount of abrasive grain that has settled to a bottom portion of the tank is then measured. The wire slicing slurry and the first amount of the solvent are vibrated for a second predetermined period of time. A second amount of abrasive grain that has settled to the bottom portion of the tank is then measured. The wire slicing slurry is then vibrated for the second predetermined period of time when the second measured amount of settled abrasive grain is greater than the first measured amount of settled abrasive grain. Substantially all of a first remaining liquid suspension is removed when the second measured amount of settled abrasive grain is less than or equal to the first measured amount of settled abrasive grain.

Yet another aspect is a system for separating an abrasive from an oil-based slurry. The system comprises a substantially enclosed tank, an ultrasonic agitator, and a back pressure regulator. The tank has an inlet for receiving an oil-based slurry and an outlet for removing at least a liquid suspension. The ultrasonic agitator is in fluid communication with the tank and is operable to ultrasonically excite the oil-based slurry as it is pumped through the ultrasonic agitator. The back pressure regulator is in fluid communication with the ultrasonic agitator and the tank and is operable to regulate the pressure of the oil-based slurry as it flows through the ultrasonic agitator.

Still another aspect is a method for recovering abrasive grain from slurry. The method comprises diluting the slurry with a first amount of a solvent in a container, wherein the slurry includes at least a liquid suspension medium and the abrasive grain. The slurry and the first amount of the solvent are then ultrasonically agitated. At least some of the abrasive grain is allowed to settle to a bottom portion of the container. Substantially all of a first remaining liquid suspension is removed from the container. The settled abrasive grain is then heated.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic of a system for processing abrasive wire-slicing slurry;

FIG. 2 is a flow diagram depicting a method for processing slurry using ultrasonic agitation;

FIG. 3 is a flow diagram depicting another method for processing slurry using ultrasonic agitation;

FIG. 4 is a flow diagram depicting still another method for processing slurry using ultrasonic agitation;

FIG. 5 is a flow diagram depicting a method for processing slurry using vibration;

FIG. 6 is a flow diagram depicting another method for processing slurry using vibration; and

FIG. 7 is a flow diagram depicting yet another method for processing slurry using vibration.

### DETAILED DESCRIPTION

The embodiments described herein are generally directed to systems and methods of processing slurries to recover and separate materials contained therein. For example, the embodiments described herein may be used in the processing of abrasive slurry used in silicon wafer slicing processes. The abrasive slurry is used in a wire saw that slices silicon wafers from an ingot. Other embodiments, while not explicitly described herein, may process other types of abrasive slurries used in different processes. Moreover, the embodiments are not limited to the processing of abrasive slurries. For example, the embodiments are equally well-suited for use in processing slurry used in a grinding or boring operation. In these embodiments, slurry containing cutting lubricants, fine particles of the cut material, and particles from the grinding or boring tool may be processed to recover and separate the materials contained therein.

Prior to initiation of the wire slicing operation, the abrasive slurry includes a liquid suspension medium (i.e., an oil-based coolant and/or lubricant), an additive such as hydrated clay or bentonite, and abrasive grains or grit (i.e. silicon carbide (SiC) or diamond). After slicing has begun, the slurry also includes fine particles of silicon from the slicing of the ingot and fine metal particles abraded from the wire in the wire saw. In order to reduce the amount of waste generated by silicon wafer production processes, as well as reduce the costs associated with silicon wafer production, it is desirable to regenerate or recycle the exhausted abrasive slurry used in slicing the silicon wafers from the silicon ingots.

As used herein, the term “exhausted slurry” refers to slurry which is essentially no longer suitable for purposes of slicing silicon wafers from a silicon ingot. According to some embodiments, the slurry becomes exhausted after four ingots have been sliced. The slurry may become exhausted because the fine silicon particles and fine metal particles abraded from the wire compete with or obstruct the abrasive grains from being drawn into the cutting region by the wire. The fine silicon and metal particles act as a diluting and lubricating agent and reduce the number of abrasive grains per unit volume of slurry.

The overall diameter of the abrasive grains is greater than that of both the fine silicon and metal particles. For example, the diameter of the fine silicon and metal particles typically are in the range of one to five microns, while the diameter of the abrasive grains is typically in the range of 10 to 20 microns. Without being held to any particular theory, it is believed that the additive (e.g., hydrated clay or bentonite) forms a lattice work in the liquid suspension medium. The lattice work entraps or suspends the abrasive grains in the liquid suspension medium and prevents the abrasive grains from otherwise settling to the bottom of the tank containing the liquid suspension medium.

When the slurry is exhausted, it is desirable to process the slurry to separate the components thereof for a variety of reasons. For example, the abrasive grains (e.g., SiC or diamond) are relatively expensive and are often not significantly degraded during the slicing operation. Accordingly, the abrasive grains may be reused in another abrasive slurry composition. Moreover, the fine silicon particles can often be recycled and used in the formation of additional silicon ingots.

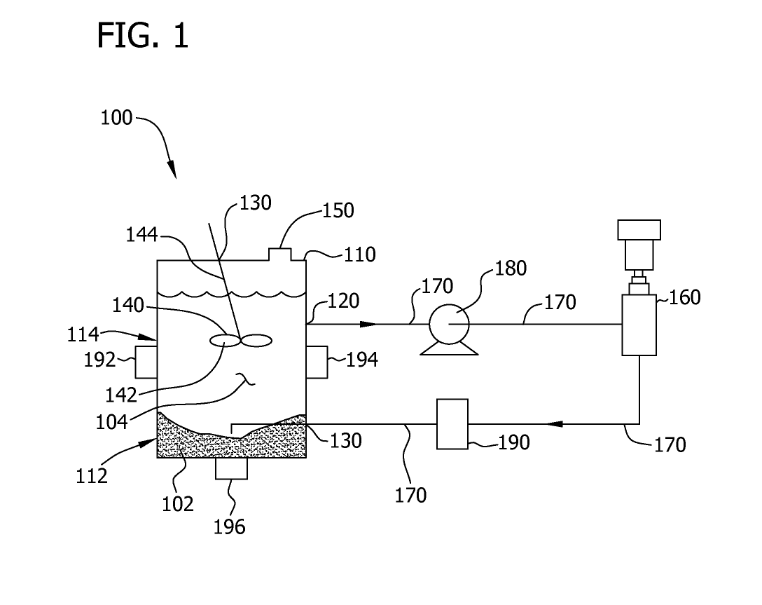

FIG. 1 depicts a schematic of an exemplary system 100 for processing abrasive slurry. The system 100 may be used to process any abrasive slurry, although specific reference will be made herein to abrasive slurries used in wire saws for slicing silicon wafers from a silicon ingot. A substantially enclosed tank 110 (broadly, a “container”) is provided to process the slurry. In the embodiment shown in FIG. 1, abrasive grain 102 has settled to a bottom portion 112 of the tank 110. In other embodiments, and in particular those where slurry has just been pumped into the tank 110, the abrasive grain 102 is distributed through the slurry in the tank. A generally liquid material includes at least the liquid suspension medium and is indicated generally at 104 is disposed in an upper portion 114 of the tank 110. The generally liquid material may also contain abraded metal particles from the wire saw, silicon fines formed during the slicing of the silicon ingot, and solvent. Together with the abrasive grain 102, the generally liquid material 104 forms the slurry.

The tank 110 has an inlet 120 and an outlet 130 to supply the tank with slurry and remove materials therefrom. The tank 110 may be constructed out of any suitable material, such as metal, plastic, or any combination thereof. The tank 110 may have bracing disposed externally or internally to strengthen the tank and enable it to withstand elevated pressures therein. The tank 110 may also include a heater, as further described below. Moreover, the tank 110 may have a lid or other structure that is removable therefrom to permit servicing of the interior of the tank.

A stirrer port 130 and a corresponding stirrer 140 are used to stir the slurry inside of the tank. The stirrer port 130 may incorporate a seal or other equivalent structure to prevent slurry or other gases from escaping from the tank 110 therethrough. The stirrer 140 has one or more vanes 142 coupled to a shaft 144. The shaft 144 is in turn rotated by a suitable drive source (not shown). A vapor conservation port 150 is used to selectively vent vapors from the tank 110 in the embodiment of FIG. 1. Vapors may also be prevented from exiting the tank 110 by the vapor conservation port 150. The amount of solvent that evaporates and escapes from the tank 110 can thus be greatly reduced and/or eliminated by the vapor conservation port 150. Accordingly, the amount of solvent that must be added to the tank 110 to replace the evaporated solvent is correspondingly greatly reduced and/or eliminated.

In one embodiment, an ultrasonic agitator 160 is used to ultrasonically excite the slurry contained in the tank 110. The ultrasonic agitator 160 is generally operable at frequencies of about 20 kHz and higher. The ultrasonic agitator 160 is a flow-through cell in the embodiment of FIG. 1. For example, the ultrasonic agitator 160 may be an ultrasonic flow-through cell similar to or the same as those manufactured Hielsher Ultrasonics GmbH of Teltow, Germany. However, in other embodiments, the ultrasonic agitator 160 may be any device which functions to ultrasonically agitate the slurry. As the slurry flows through the ultrasonic agitator 160 it is brought into contact with an ultrasonic horn (not shown) in the agitator. The ultrasonic horn is coupled to a suitable transducer and is designed to vibrate ultrasonically upon excitation of the transducer. While only one ultrasonic agitator 160 is shown in the embodiment of FIG. 1, multiple agitators may be used without departing from the scope of the embodiments. For example, multiple agitators may be arranged in series or parallel banks to increase the amount of ultrasonic energy applied to the slurry.

The ultrasonic agitator 160 is in fluid communication with tank 110 through pipes 170 or tubes (broadly, “fluid communication means”). The slurry is pumped through the ultrasonic agitator 160 with a pump 180. The pump 180 is of any suitable type, such as a centrifugal, progressive cavity, or positive displacement pump. In the embodiment of FIG. 1, the pump 180 pulls the slurry from the tank 110 through the pipes 170 and then pushes it into the ultrasonic agitator 160. The pump 180 may be positioned differently in relation to the tank 110 and the ultrasonic agitator 160 without departing from the scope of the embodiments.

A backpressure regulator 190 is in fluid communication with the ultrasonic agitator 160 and positioned such that slurry flows into and through the backpressure regulator after flowing through the ultrasonic agitator. The backpressure regulator 190 functions to restrict the flow of slurry therethrough. The backpressure regulator 190 is a normally closed valve and provides an obstruction to the flow of slurry therethrough, thus enabling the regulation and control of the pressure of the slurry. Accordingly, the pressure in the pipes 170 and the ultrasonic agitator 160 may be controlled by the backpressure regulator 190. Moreover, by restricting the flow of slurry therethrough, the backpressure regulator 190 can also regulate the pressure of the slurry in the tank 110. Accordingly, the pressure of the slurry in the tank 110 and the ultrasonic agitator 160 can be significantly greater than the outside, ambient pressure. Increasing the pressure of the slurry while it is in the ultrasonic agitator 160 enables the prevention and control of cavitations of the slurry.

Cavitation generally occurs in the slurry in a non-inertial form due to ultrasonic agitation of the slurry. It is believed that the cavitation overcomes or significantly reduces the adhesion forces between the oil-based suspension medium and the abrasive grain and thus aids in loosening or removes the abrasive grain from the medium. The backpressure regulator 190 thus enables control of both the flow rate and pressure of the slurry as it passes through the ultrasonic agitator 160. Moreover, while the backpressure regulator 190 is used in the embodiment of FIG. 1, other embodiments use a pressure regulator instead of or in addition to the backpressure regulator. The pressure regulator may be positioned near the tank and upstream of the ultrasonic agitator 160. While the embodiment shown in FIG. 1 depicts the ultrasonic agitator 160 as being separate from the tank 110, the agitator may instead be positioned within the tank. In these embodiments, the pump 180 and backpressure regulator 190 may still be used to circulate the slurry and regulate the pressure in the tank 110.

FIG. 1 also depicts a first vibrator 192 and a second vibrator 194 positioned adjacent the sides of the tank 110. A third vibrator 196 is positioned adjacent the bottom portion 112 of the tank 110. In one embodiment, the vibrators 192, 194, 196 are operable to generate vibrations in the range of 10 Hz to 5 kHz, while in another embodiment they are operable to generate vibrations in the range of 15 Hz to 200 Hz. In still other embodiments, the vibrators 192, 194, 196 are operable to generate vibrations in the range of 20 Hz to 100 Hz.

The vibrators 192, 194, 196 are disposed externally of the tank 110 (as opposed to within the tank). The location of the vibrators 192, 194, 196 shown in FIG. 1 is exemplary in nature, and the vibrators may instead be positioned at any location on the tank with departing from the scope of the embodiments. Moreover, while the vibrators 192, 194, 196 are positioned externally of the tank 110 in FIG. 1, in other embodiments one or more of the vibrators may be positioned in the interior of the tank 110. In such an embodiment, one or more of the vibrators 192, 194, 196 can be coupled to the walls of the tank 110 or may instead be suspended within the tank and not coupled to the walls. Further, any number of vibrators may be used in the embodiment of FIG. 1 without departing from the scope thereof.

The vibrators 192, 194, 196 are mechanical devices capable of inducing vibration in the tank 110 and the contents contained therein (e.g., the slurry). The vibrators 192, 194, 196 are coupled to the tank 110 at their respective locations by any suitable fastening system (e.g., bolting or welding). The fastening system is configured to couple the vibrators 192, 194, 196 to the tank such that vibrations generated by the vibrators are not appreciably dampened by the fastening system and instead are transmitted to the tank 110. Moreover, the tank 110 may be constructed from materials which do not appreciably dampen vibrations generated by the vibrators 192, 194, 196.

In one embodiment, each of the vibrators 192, 194, 196 comprise a drive source coupled to an eccentric weight. Upon rotation of the eccentric weight by the drive source, a vibration is generated that has a frequency corresponding to the rate at which the eccentric drive source is rotated. A control system (not shown) or other suitable system is used to control operation of the vibrators 192, 194, 196. The control system is operable to vary the frequency of the vibrations generated by the vibrators 192, 194, 196 by varying the rate of rotation of the drive sources. Accordingly, the frequency of the vibrations is increased by increasing the rate of rotation of the drive sources, while the frequency is decreased by reducing the rate of rotation of the drive sources. Moreover, in some embodiments the control system is operable to adjust the frequency of vibrations of the vibrators 192, 194, 196 independently of each other such that each of the vibrators can vibrate at different frequencies. The amplitude of the vibrations generated by the vibrators 192, 194, 196 can be varied by increasing or decreasing the mass of the eccentric weight to respectively increase or decrease the amplitude of the vibrations.

In other embodiments, the vibrators 192, 194, 196 are pneumatically operated devices. In these embodiments, the control system is operable to control the flow and/or pressure of a pressurized gas (e.g., air) to the vibrators 192, 194, 196 in order to control the frequency and/or amplitude of vibrations generated by the vibrators. In other embodiments, multiple magnets (not shown) are positioned externally of the tank 110. The magnets attract and retain ferrous particles in the slurry and thus aid in separation of ferrous particles from the slurry.

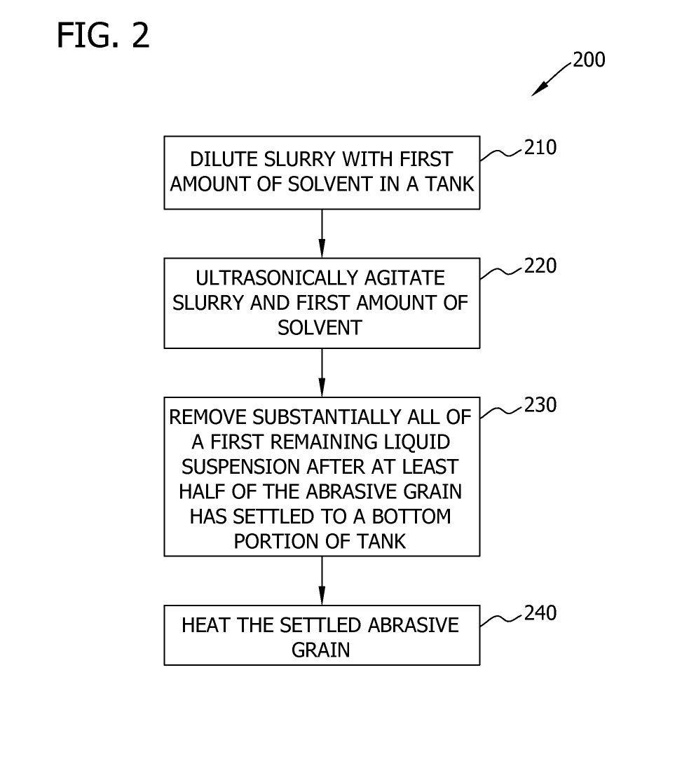

FIG. 2 is a flow diagram depicting a method 200 for recovering abrasive from slurry. The slurry includes at least a liquid suspension medium and an abrasive grain. In the embodiment of FIG. 2, the slurry is an exhausted abrasive slurry used in a wire saw comprising an oil-based liquid suspension medium, abrasive grains or grit, fine particles of the material being cut (e.g., silicon), and metal particles abraded from the wire used in the wire saw. Prior to diluting the slurry in the tank, the slurry is pumped or otherwise flows into the tank through one or more pipes or tubes into the inlet from the wire saw or another intermediary holding tank.

The method 200 is operable with the system described above in relation to FIG. 1, but may also be used with other systems. The method 200 begins in block 210 with diluting the slurry with a first amount of a solvent in the tank. The solvent may be selected from a variety of appropriate solvents (e.g., naphtha, d-limonene, n-methylpyrrolidone, dibasic esther, or any other solvent that is miscible when combined with the oils in the slurry). The solvent may be diluted or mixed with an amount of surfactant in order to increase its miscibility with the oils contained in the slurry.

The first amount of solvent is generally greater than the volume of slurry in the tank. In one embodiment, the ratio of the first amount of solvent and the slurry is approximately 2:1, while in other embodiments the ratio may vary from 1:1 to 4:1. Selection of the ratio of the first amount of solvent to the slurry is largely dependent on two factors: the power of ultrasonic energy applied to the first amount of solvent and the amount of time that ultrasonic energy must be applied thereto. Higher ultrasonic power levels require less time and permit reduced ratios of the first amount of solvent and the slurry, such as 1.5:1. Lower ultrasonic power levels require more time and increased ratios of the first amount of solvent and the slurry, such as in the range of 3:1 to 4:1. Accordingly, as the ratio of the first amount of solvent to the slurry increases, the abrasive grains are more easily separable from the slurry with relatively lower ultrasonic power levels.

After addition of the first amount of solvent is added to slurry, the two may be mixed or stirred together by the stirrer. The slurry and the solvent are together referred to as the “composition”. The composition is then ultrasonically agitated in block 220. In embodiments using an ultrasonic flow-through cell, the power density resultant from the ultrasonic agitation may be in the range of 100 watts/liter to well over 1000 watts/liter in some embodiments. Power densities resultant from conventional ultrasonic agitators disposed in an open tank are in the range of 15 watts/liter to 100 watts/liter. Moreover, the ultrasonic frequency at which the ultrasonic agitator resonates may be in the range of between 15 kHz to 400 Khz. The composition may be ultrasonically agitated by being pumped through pipes or hoses into and through an ultrasonic flow cell, as described above, and then passed through the backpressure regulator before being returned to the tank. The ultrasonic agitator ultrasonically excites the composition, thus enabling the separation of the abrasive grain from the rest of the composition.

Without being bound to any particular theory, it is believed that the cavitations initiated in the composition by the ultrasonic agitator cause the relatively large abrasive grains (when compared to the other particulates in the slurry) to separate from the other components of the slurry. The cavitations induce shear forces in the composition. These shear forces, the ultrasonic agitation, and/or the cavitations are believed to destroy or alter the lattice or matrix-like structure formed by the additives (e.g., hydrated clay or bentonite) in the slurry. The abrasive grains are thus no longer suspended in the composition by the additives and begin to separate and settle out from the other components of the composition.

The composition is pumped from the tank through the ultrasonic agitator and then through the backpressure regulator and back into the tank by the pump. The pump thus circulates the composition through the ultrasonic agitator for a period of time. In some embodiments, the composition may be circulated through the ultrasonic agitator for a fixed period or a range of time (e.g., 30 to 60 minutes). In other embodiments, the amount of time may be dependent upon the characteristics of the system. For example, larger volumes of composition require corresponding longer circulation times compared to smaller volumes of composition. Moreover, the use of multiple agitators in the system permits shorter circulation times. Higher-power agitators likewise enable shorter circulation times. Moreover, in most embodiments an upper limit will be reached after which additional circulation and ultrasonic agitation does not appreciably increase the amount of abrasive grains that separate from the rest of the composition.

As the composition passes through the ultrasonic agitator, the abrasive grain gradually begins to separate from the rest of the composition. According to some embodiments, the circulation and ultrasonic agitation of the composition may cease upon the abrasive grain beginning to settle from the rest of the composition.

The separated abrasive grain thus settles to the bottom portion of the tank upon being returned thereto. Over time, more of the abrasive grain in the composition separates and settles to the bottom portion of the tank. The rate at which the grain settles to the bottom portion of the tank may be monitored. In some embodiments, the rate is monitored by visual inspection of the composition and the contents of the tank with the aid of one or more photographic devices and automated image processing and analyzing systems. In another embodiment, the density of composition may be monitored to determine the relative amount of abrasive grain that remains in the composition. The abrasive grains are comparatively heavier than the other components of the composition, and thus a lower density composition indicates the presence of a reduced amount of abrasive grain. Accordingly, rather than circulating the composition for a set amount of time, the composition may be circulated until the derivative of the rate of change nears zero or another predetermined point—and thus circulation may cease after a set portion or substantially all of the abrasive grain has separated from the composition and settled to the bottom portion of the tank. However, the circulation may cease before substantially all of the abrasive grain has separated from the composition and has settled to the bottom portion of the tank without departing from the scope of the embodiments.

The portion of the composition remaining after at least some of the abrasive grain has settled to the bottom portion of tank is referred to as a first remaining liquid suspension. In the embodiment of FIG. 2, substantially all of the first remaining liquid suspension is removed in block 230 from the tank after at least half of the abrasive grain has settled to the bottom portion of the tank. In other embodiments, the first remaining liquid suspension is removed from the tank by pumping, skimming, or draining therefrom after substantially all (e.g., greater than about 75%) of the abrasive grain has settled to the bottom portion of tank. As described above, the composition may be monitored to determine when the abrasive grain has separated from the other components of the composition. Accordingly, the first remaining liquid suspension may thus be removed from the tank after a period of time has elapsed since the commencement of ultrasonic agitation. The period of time required for the abrasive grain to separate from the other components of the composition is referred to as the settling time. The settling time may be dependent upon the ultrasonic power levels, the geometry of the tank and other components of the system, and the components of the composition.

In some embodiments, the settling time may be calculated by applying the principles of sedimentation. A sedimentation coefficient s is equal to

$$s ≡ \frac{{v}_{t}}{a} ,$$

where vₜ is the sedimentation velocity (i.e., terminal velocity) and a is the applied acceleration. In the embodiments described herein, the applied acceleration a is equal to the gravitational acceleration g (i.e., 9.8 m/s²). The sedimentation constant s may be derived empirically. Accordingly, once the sedimentation velocity is known, the maximum distance the particle travels is the depth of the tank and the time required is

$$\frac{{t}_{d}}{{v}_{t}}$$

where t_{d} is the depth of the tank.

In some embodiments, an additional amount of first solvent may be added to the settled abrasive grain after the removal of the first remaining liquid suspension, and the steps described above are repeated. This process may occur a number of times (e.g., two to ten times) in order to remove additional liquid-suspension media from the abrasive grain. Additionally, these subsequent steps may utilize a different type of solvent than the first solvent. For example, the different type of solvent may be KOH, water, or acid (e.g., oxalic acid).

The settled abrasive grain is then heated in block 240. The heating of the settled abrasive grain may take place within the tank. A heater (e.g., heating elements) may be integrated into the tank or disposed thereon or the exterior of the tank may be heated by a heat source (e.g., a burner or other suitable device). In other embodiments the settled abrasive grain may be removed from the tank before being heated. Heating the settled abrasive grain dries and removes moisture therefrom. According to some embodiments, the settled abrasive grain may be heated for between 30 minutes and four hours at temperatures ranging from about 100° C. to about 250° C. The length of time may vary depending on the moisture content of the settled abrasive grain and how quickly it may be heated and then cooled after it has dried. The temperatures may range on the lower end from the boiling point of the solvent. Higher temperatures may be used to more quickly dry the settled abrasive grain. However, higher temperatures require greater amounts of heat and correspondingly incur an increased cost. After drying of the grain it may be ground or otherwise broken up and reused in wire slicing operations. Accordingly, the method 200 enables the efficient separation of used abrasive grain from an oil-based wire-slicing slurry without the use of strong solvents.

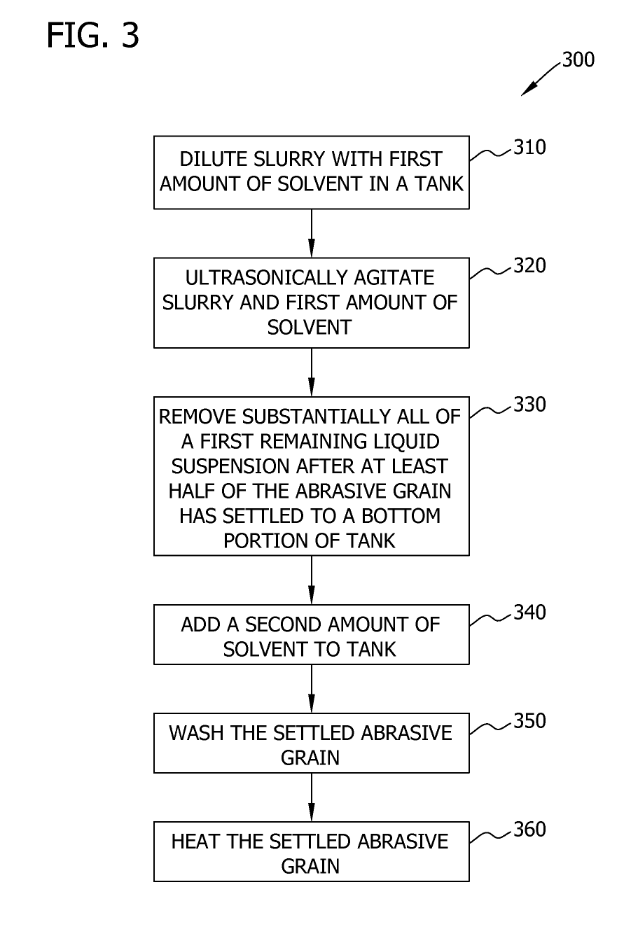

FIG. 3 is a flow diagram depicting a method 300 for recovering abrasive from a slurry. The method 300 is similar to the method 200 described above, however additional processing of the slurry is undertaken to wash the abrasive grain after it has been separated from the other components of the slurry. In the embodiment of FIG. 3, the slurry is an exhausted abrasive slurry used in a wire saw comprising an oil-based liquid suspension medium, abrasive grains or grit, fine particles of the material being cut (e.g., silicon), and metal particles abraded from the wire used in the wire saw. The method 300 is operable with the system described above in relation to FIG. 1, but may also be used with other systems. The method 300 begins with diluting 310 the slurry with a first amount of a solvent in the tank. The first amount of solvent is generally greater than the volume of slurry in the tank. As described above, the ratio of the first amount of solvent and the slurry is approximately 2:1, while in other embodiments the ratio may vary from 1:1 to 4:1.

After the first amount of solvent is added to the slurry, the first amount of solvent and the slurry together referred to as the “composition”, they are ultrasonically agitated in block 320. The composition may be ultrasonically agitated by being pumped through pipes or hoses into and through an ultrasonic flow cell, as described above, and then passed through the backpressure regulator before being returned to the tank. The ultrasonic agitator ultrasonically excites the composition, thus enabling the separation of the abrasive grain from the rest of the composition. Moreover, it is believed that the cavitation initiated in the composition by the ultrasonic agitator causes the relatively large abrasive grains (when compared to the other particulates in the slurry) to separate from the other components of the slurry.

The composition is pumped from the tank through the ultrasonic agitator and then through the backpressure regulator and back into the tank by the pump. The pump thus circulates the composition through the ultrasonic agitator for a period of time. In some embodiments, the composition may be circulated through the ultrasonic agitator for a fixed period of time (e.g., 30 minutes). In other embodiments, the amount of time may be dependent upon the characteristics of the system.

As the composition passes through the ultrasonic agitator, the abrasive grain gradually begins to separate from the rest of the composition. The separated abrasive grain thus settles to the bottom portion of the tank upon being returned thereto. Over time, more of the abrasive grain in the composition separates and settles to the bottom portion of the tank. The portion of the composition remaining after at least some of the abrasive grain has settled to the bottom portion of tank is referred to as a first remaining liquid suspension. In the embodiment of FIG. 3, substantially all of the first remaining liquid suspension is removed in block 330 from the tank after at least half of the abrasive grain has settled to the bottom portion of the tank. In another embodiment, substantially all of the first remaining liquid suspension is removed from the tank after at least some of the abrasive grain has settled to the bottom portion of the tank.

A second amount of solvent is added in block 340 to the settled abrasive grain contained in the tank. The second amount of solvent may be substantially less than the first amount of solvent. For example, the ratio of the second amount of solvent to original amount of slurry that the operation began with at block 310 may be in the range of about 0.2:1 to about 0.5:1. The second amount of solvent and the settled abrasive grain may then be stirred or mixed by the stirrer or any other suitable mixing mechanism. Moreover the second amount of solvent may have a different chemical composition that the first composition. For example, the second amount of solvent may be water with a surfactant (e.g., a soap or soap-like substance, such as dishwashing soap) constituting less than 1% of the solvent.

The settled abrasive grain is then washed in block 350. Washing the settled abrasive grain can be accomplished in a variety of ways. In one embodiment, the settled abrasive grain is washed by being mixed with the second amount of solvent by the stirrer or other suitable mixing or mechanism. Once mixed, the second amount of solvent and the previously settled abrasive grain form a mixture. The mixture is then pumped through the ultrasonic agitator. The period of time may be a defined period, such as anywhere from less than five minutes to an hour or more. The abrasive grain begins to settle to the bottom portion of the tank while being ultrasonically agitated and may finish settling after the ultrasonic agitation has ceased. The second amount of solvent and any other liquids may then be removed, leaving the settled abrasive grain.

The washing process may be repeated multiple times according to one embodiment. For example, the washing process may be repeated from two to ten times in order to ensure that the settled abrasive grain is free from contaminants. In some embodiments, the mixture is heated as described above in between each washing cycle. In addition, after each washing cycle the mixture may be analyzed to determine its composition. The mixture may be analyzed using a particle-sizing apparatus (e.g., a Coulter counter or other light and/or laser scattering particle-size apparatus). The mixture may also be analyzed by drying it as described above and then analyzing it for the presence of metals and silicon by wet chemical analysis. For example, a gravimetric process may be utilized comprising weighing the dry, settled abrasive grain, etching the grain with an etchant (e.g., KOH), rinsing and then drying the settled abrasive grain, and then weighing the grain again. The difference in the respective weights of the settled abrasive grain indicates the amount of silicon or other metals that were digested by the acid in the etchant. Moreover, in other embodiments the settled abrasive grain may be further heated and gas chromatography performed on the off-gas to analyze its composition. A decision may then be made as to whether to wash the mixture again based on its composition. For example, if the mixture has a relatively high composition of abrasive grain (e.g., 80% to 95%), the mixture may not need to be washed again. Moreover, if the mixture is relatively free from contaminants, the mixture may not need to be washed again. Additionally, the final washing cycle may only utilize water as the solvent.

The settled abrasive grain is then heated in block 360. The heating of the settled abrasive grain may take place within the tank. As described above, heating elements may be integrated into the tank or disposed thereon or the exterior of the tank may be heated by a heat source (e.g., a burner or other suitable device). In other embodiments, the settled abrasive grain may be removed from the tank before being heated, or a removable tank bottom (e.g., a pan) may be removed from the tank and heated. Heating the settled abrasive grain dries and removes moisture therefrom. After drying of the grain it may be ground or otherwise broken up and reused in wire slicing operations. Accordingly, the method 300 enables the efficient separation of used abrasive grain from an oil-based wire-slicing slurry without the use of strong solvents.

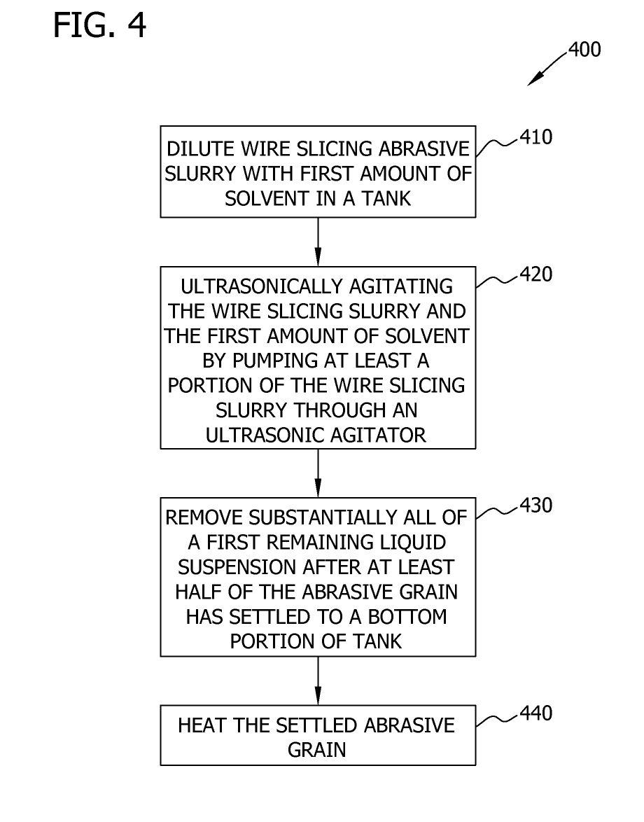

FIG. 4 is a flow diagram depicting a method 400 of recovering an abrasive from a wire slicing abrasive slurry. The method 400 is similar to the method 200 described above, although method 400 is specifically directed to processing wire slicing abrasive from a silicon wafer slicing process. The slurry includes at least a liquid suspension medium and an abrasive grain. In the embodiment of FIG. 2, the slurry is an exhausted abrasive slurry used in a wire saw comprising an oil-based liquid suspension medium, abrasive grains or grit, fine particles of silicon, and metal particles abraded from the wire used in the wire saw. Prior to diluting the slurry in the tank, the slurry is pumped or otherwise flows into the tank, e.g., through one or more pipes into the inlet from the wire saw or another intermediary holding tank.

The method 400 is operable with the system described above in relation to FIG. 1, but may also be used with other systems. The method 400 begins in block 410 with diluting the wire-slicing abrasive slurry with a first amount of a solvent in the tank. The first amount of solvent is generally greater than the volume of slurry in the tank. As described above, the ratio of the first amount of solvent and the slurry is approximately 2:1, while in other embodiments the ratio may vary from 1:1 to 4:1.

After the first amount of solvent is added to the slurry, together referred to as the “composition”, they are ultrasonically agitated in block 420. The composition may be ultrasonically agitated by being pumped through pipes or hoses into and through an ultrasonic flow cell, as described above, and then passed through the backpressure regulator before being returned to the tank. The ultrasonic agitator ultrasonically excites the composition, thus enabling the separation of the abrasive grain from the rest of the composition. The composition is pumped from the tank through the ultrasonic agitator and then through the backpressure regulator and back into the tank by the pump. The pump thus circulates the composition through the ultrasonic agitator for a period of time. In some embodiments, the composition may be circulated through the ultrasonic agitator for a fixed period of time (e.g., 30 minutes). In other embodiments, the amount of time may be dependent upon the characteristics of the system.

As the composition passes through the ultrasonic agitator, the abrasive grain gradually begins to separate from the rest of the composition. The separated abrasive grain thus settles to the bottom portion of the tank upon being returned thereto. Over time, more of the abrasive grain in the composition separates and settles to the bottom portion of the tank. The portion of the composition remaining after at least some of the abrasive grain has settled to the bottom portion of tank is referred to as a first remaining liquid suspension. In the embodiment of FIG. 4, substantially all of the first remaining liquid suspension is removed in block 430 from the tank after at least half of the abrasive grain has settled to the bottom portion of the tank. In at least some embodiments, the first remaining liquid suspension may be further processed after it is removed from the tank to recover the silicon fines contained therein.

The settled abrasive grain is then heated in block 440. The heating of the settled abrasive grain may take place within the tank. Heating elements may be integrated into the tank or disposed thereon or the exterior of the tank may be heated by a heat source (e.g., a burner or other suitable device). In other embodiments the settled abrasive grain may be removed from the tank before being heated. Heating the settled abrasive grain dries and removes moisture therefrom. After drying of the grain it may be ground or otherwise broken up and reused in wire slicing operations. Accordingly, the method 400 enables the efficient separation of used abrasive grain from an oil-based wire-slicing slurry without the use of strong solvents.

The embodiments described herein utilize a closed tank in conjunction with an ultrasonic agitator to separate the components of an abrasive slurry. The utilization of a closed tank instead of an open tank provides numerous advantages over systems utilizing open tanks. For example, the use of a closed tank permits the safe use of flammable or volatile solvents as the vapors produced therefrom are contained in the tank. The vapors may thus be vented under controlled conditions and effectively controlled. Moreover, the closed tank in conjunction with the pump and backpressure regulator enables the pressurization of the tank. The pressurization of the tank in turn enables the control of the cavitation induced in the slurry by the ultrasonic agitator. The cavitation is thus controllable such that only the abrasive grains are separated from the slurry, while the other components (silicon fines, abraded particles from the wire saw) remain suspended in the liquid suspension medium.

Moreover, the closed tank enables the generation of relatively high ultrasonic power densities in the ultrasonic flow cell, such as 100 watts/liter or higher. Such relatively high ultrasonic power densities are not readily achievable in open tanks. Furthermore, the use of a closed tank or circulating pump and ultrasonic flow-through agitator or cell permits the entire volume of the composition to pass through the cell. In open tank systems, the agitator is merely disposed in the tank and consequently the entire volume of the contents of the tank may not contact or be brought into close enough proximity with the agitator to make the process effective.

In addition, the temperature of the system may be precisely controlled by surrounding the ultrasonic agitator, the vibrators, the tank, and/or the pipes connecting each with heating and/or cooling elements. The ultrasonic agitator generates heat and accordingly heats the composition as it flows therethrough. If the composition is not sufficiently cooled by an external source, the solvent contained therein may boil. In one embodiment, the external cooling source is a heat exchanger using a cooling fluid.

The use of an ultrasonic flow cell as an agitator permits the composition to be cooled immediately after exiting the flow cell, and before returning to the tank. Cooling the relatively small volume of mixture as it exits the flow cell is more efficient than cooling than cooling the entire volume of mixture contained in the tank as the volume of mixture being cooled at any point in time is comparatively small and the cooling occurs at or near the source of the heat. Moreover, the recovered heat in the cooling fluid is in a more concentrated form (i.e., a relatively small stream) and thus has a greater change in temperature. In open tank systems, a large cooling system is used to cool the contents of the tank. While the same amount of thermal energy is removed by both cooling systems, the large cooling coils do not achieve the same change in temperature in the cooling fluid. Accordingly, the cooling fluid used in the embodiments described herein is of a greater temperature than that used in open-tank systems. The heat energy contained in the elevated-temperature cooling fluid may thus be used in other applications, such as heating the settled abrasive grit. While the use of a heat exchanger positioned immediately after the ultrasonic agitator is described herein, the heat exchanger may be positioned differently without departing from the scope of the embodiments. Moreover, the heat exchanger may include one or more pipes disposed either in the tank or adjacent thereto.

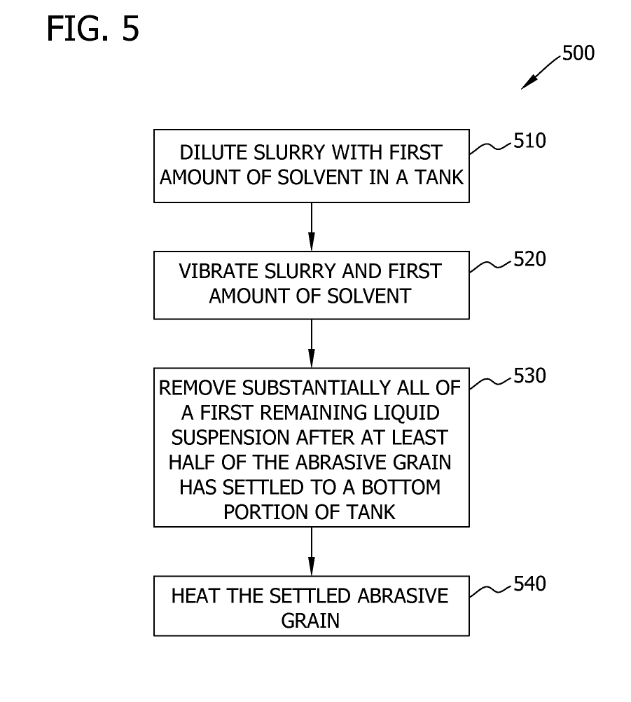

FIG. 5 is a flow diagram depicting a method 500 for recovering abrasive from slurry using vibration. The slurry includes at least a liquid suspension medium and an abrasive grain. In the embodiment of FIG. 5, the slurry is an exhausted abrasive slurry used in a wire saw comprising an oil-based liquid suspension medium, abrasive grains or grit, fine particles of the material being cut (e.g., silicon), and metal particles abraded from the wire used in the wire saw. Prior to diluting the slurry in the tank, the slurry is pumped or otherwise flows into the tank through one or more pipes or tubes into the inlet from the wire saw or another intermediary holding tank.

The method 500 is operable with the system described above in relation to FIG. 1, but may also be used with other systems. The method 500 is similar to the method 200 described above, except that in the method of FIG. 5 the slurry and first amount of solvent are vibrated by the vibrators described in FIG. 1. However, the method 500 may also be used in conjunction with any of the methods 200, 300, 400 such that the slurry is subject to both vibration and ultrasonic agitation.

The method 500 begins with diluting 510 the slurry with a first amount of a solvent in the tank. The solvent may be selected from a variety of appropriate solvents (described above in relation to FIG. 2). The first amount of solvent is generally greater than the volume of slurry in the tank. In one embodiment, the ratio of the first amount of solvent and the slurry is approximately 2:1, while in other embodiments the ratio may vary from 1:1 to 4:1. Selection of the ratio of the first amount of solvent to the slurry is largely dependent on two factors: the amplitude of vibrations applied to the first amount of solvent and the amount of time that the first amount of solvent and slurry are vibrated. Higher amplitude vibrations require less time and permit reduced ratios of the first amount of solvent and the slurry, such as 1.5:1. Lower amplitude vibrations require more time and increased ratios of the first amount of solvent and the slurry, such as in the range of 3:1 to 4:1. Accordingly, as the ratio of the first amount of solvent to the slurry increases, the abrasive grains are more easily separable from the slurry with relatively lower amplitude vibrations.

After addition of the first amount of solvent is added to slurry, the two may be mixed or stirred together by the stirrer. The slurry and the solvent are together referred to as the “composition”. The composition is then vibrated in block 520. The composition is vibrated with the vibrators described above in relation to FIG. 1. When the vibrators are positioned externally of the tank, vibrations generated therefrom are transmitted through the walls of the tank and then into the composition. If the vibrators are mounted internally of the tank, vibrations generated by the vibrators are transmitted directly to the composition.

Without being bound to any particular theory, it is believed that vibrations initiated in the composition by the vibrators result in the relatively large abrasive grains (when compared to the other particulates in the slurry) separating from the other components of the slurry. The vibrations induce shear forces in the composition. These shear forces, the vibrations, and/or the cavitations are believed to destroy or alter the lattice or matrix-like structure formed by the additives (e.g., hydrated clay or bentonite) in the slurry. The abrasive grains are thus no longer suspended in the composition by the additives and begin to separate and settle out from the other components of the composition.

The composition is pumped and circulated within the tank by the pump. In some embodiments, the composition may be circulated while being vibrated, while in others the composition may not be circulated while being vibrated. The composition may be vibrated for a fixed period or a range of time (e.g., 30 to 60 minutes) in some embodiments. In other embodiments, the amount of time may be dependent upon the characteristics of the system. For example, larger volumes of composition require corresponding longer vibrations times compared to smaller volumes of composition. Moreover, the use of multiple vibrators in the system permits shorter vibration times. Higher-amplitude vibrations likewise enable shorter vibration times. Moreover, in most embodiments an upper limit will be reached after which additional vibration does not appreciably increase the amount of abrasive grains that separate from the rest of the composition. According to some embodiments, the vibration of the composition may cease upon the abrasive grain beginning to settle from the rest of the composition.

Accordingly, as the composition is vibrated, the separated abrasive grain settles to the bottom portion of the tank. Over time, more of the abrasive grain in the composition separates and settles to the bottom portion of the tank. The rate at which the grain settles to the bottom portion of the tank may be monitored. In some embodiments, the rate is monitored by visual inspection of the composition and the contents of the tank with the aid of one or more photographic devices and automated image processing and analyzing systems. In another embodiment, the density of composition may be monitored to determine the relative amount of abrasive grain that remains in the composition. The abrasive grains are comparatively heavier than the other components of the composition, and thus a lower density composition indicates the presence of a reduced amount of abrasive grain. Accordingly, rather than vibrating the composition for a set amount of time, the composition may be circulated until the derivative of the rate of change nears zero or another predetermined point—and thus circulation may cease after a set portion or substantially all of the abrasive grain has separated from the composition and settled to the bottom portion of the tank. However, the circulation may cease before substantially all of the abrasive grain has separated from the composition and has settled to the bottom portion of the tank without, departing from the scope of the embodiments.

The portion of the composition remaining after at least some of the abrasive grain has settled to the bottom portion of tank is referred to as a first remaining liquid suspension. In the embodiment of FIG. 5, substantially all of the first remaining liquid suspension is removed in block 530 from the tank after at least half of the abrasive grain has settled to the bottom portion of the tank. In other embodiments, the first remaining liquid suspension is removed from the tank by pumping, skimming, or draining therefrom after substantially all (e.g., greater than about 75%) of the abrasive grain has settled to the bottom portion of tank. As described above, the composition may be monitored to determine when the abrasive grain has separated from the other components of the composition. Accordingly, the first remaining liquid suspension may thus be removed from the tank after a period of time has elapsed since the commencement of ultrasonic agitation. The period of time required for the abrasive grain to separate from the other components of the composition is referred to as the settling time. The settling time may be dependent upon the frequency and/or amplitude of the vibrations, the geometry of the tank and other components of the system, and the components of the composition. In some embodiments, the settling time may be calculated by applying the principles of sedimentation described above in relation to FIG. 2.

In some embodiments, an additional amount of first solvent may be added to the settled abrasive grain after the removal of the first remaining liquid suspension, and the steps described above are repeated. This process may occur a number of times (e.g., two to ten times) in order to remove additional liquid-suspension media from the abrasive grain. Additionally, these subsequent steps may utilize a different type of solvent than the first solvent. For example, the different type of solvent may be KOH, water, or acid (e.g., oxalic acid).

The settled abrasive grain is then heated in block 540. The heating of the settled abrasive grain may take place within the tank. A heater (e.g., heating elements) may be integrated into the tank or disposed thereon or the exterior of the tank may be heated by a heat source (e.g., a burner or other suitable device). In other embodiments the settled abrasive grain may be removed from the tank before being heated. Heating the settled abrasive grain dries and removes moisture therefrom. According to some embodiments, the settled abrasive grain may be heated for between 30 minutes and four hours at temperatures ranging from 100° C. to 250° C. The length of time may vary depending on the moisture content of the settled abrasive grain and how quickly it may be heated and then cooled after it has dried. The temperatures may range on the lower end from the boiling point of the solvent. Higher temperatures may be used to more quickly dry the settled abrasive grain. However, higher temperatures require greater amounts of heat and correspondingly incur an increased cost. After drying of the grain it may be ground or otherwise broken up and reused in wire slicing operations. Accordingly, the method 500 enables the efficient separation of used abrasive grain from oil-based wire-slicing slurry without the use of strong solvents.

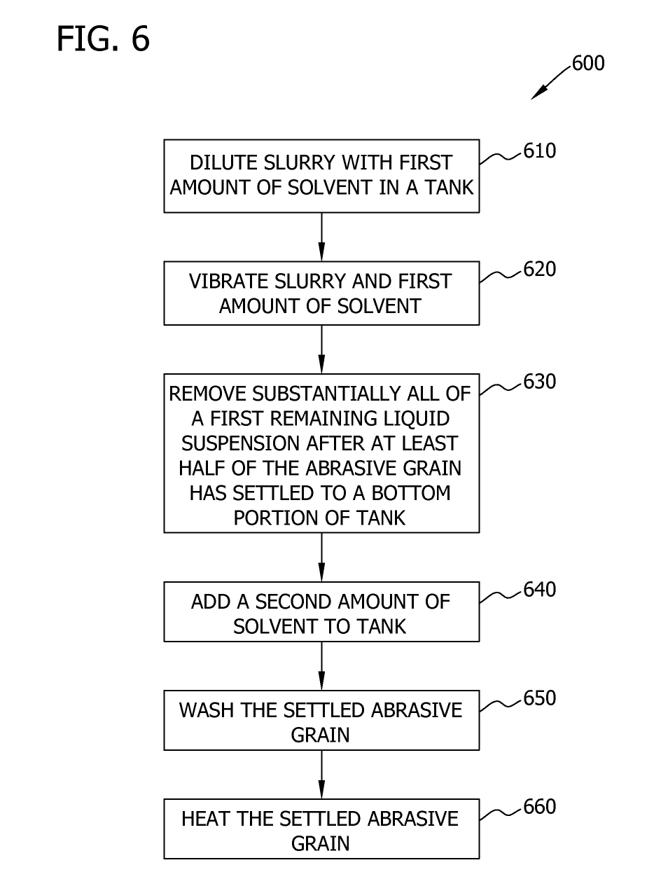

FIG. 6 is a flow diagram depicting a method 600 for recovering abrasive from a slurry. The method 600 is similar to the method 500 described above in relation to FIG. 5, however additional processing of the slurry is undertaken to wash the abrasive grain after it has been separated from the other components of the slurry. In the embodiment of FIG. 6, the slurry is an exhausted abrasive slurry used in a wire saw comprising an oil-based liquid suspension medium, abrasive grains or grit, fine particles of the material being cut (e.g., silicon), and metal particles abraded from the wire used in the wire saw.

The method 600 is operable with the system described above in relation to FIG. 1, but may also be used with other systems. The method 600 is similar to the method 300 described above, except that in the method of FIG. 6 the slurry and first amount of solvent are vibrated by the vibrators described in FIG. 1. However, the method 600 may also be used in conjunction with any of the methods 200, 300, 400 such that the slurry is subject to both vibration and ultrasonic agitation.

The method 600 begins in block 610 with diluting the slurry with a first amount of a solvent in the tank. The first amount of solvent is generally greater than the volume of slurry in the tank. As described above, the ratio of the first amount of solvent and the slurry is approximately 2:1, while in other embodiments the ratio may vary from 1:1 to 4:1.

After the first amount of solvent is added to the slurry, the two are together referred to as the “composition”. The composition is then vibrated in block 620 with the vibrators described above in relation to FIG. 1. When the vibrators are positioned externally of the tank, vibrations generated therefrom are transmitted through the walls of tank and then into the composition. If the vibrators are mounted internally of the tank, vibrations generated by the vibrators are transmitted directly to the composition. Vibration of the composition results in the separation of the abrasive grain from the rest of the composition. Moreover, it is believed that the vibrations initiated in the composition by the vibrators cause the relatively large abrasive grains (when compared to the other particulates in the slurry) to separate from the other components of the slurry.

The composition is pumped and circulated through the tank by the pump. The pump thus circulates the composition through the tank for a period of time. In some embodiments, the composition may be circulated while being vibrated, while in others the composition may not be circulated while being vibrated. The combination may be vibrated for a fixed period of time (e.g., 30 minutes) or a range of time (e.g., 30 to 60 minutes). In other embodiments, the amount of time may be dependent upon the characteristics of the system.

As the composition is vibrated, the abrasive grain gradually begins to separate from the rest of the composition and settles to the bottom portion of the tank. Over time, more of the abrasive grain in the composition separates and settles to the bottom portion of the tank. The portion of the composition remaining after at least some of the abrasive grain has settled to the bottom portion of tank is referred to as a first remaining liquid suspension. In the embodiment of FIG. 6, substantially all of the first remaining liquid suspension is removed in block 630 from the tank after at least half of the abrasive grain has settled to the bottom portion of the tank. In another embodiment, substantially all of the first remaining liquid suspension is removed from the tank after at least some of the abrasive grain has settled to the bottom portion of the tank.

A second amount of solvent is added in block 640 to the settled abrasive grain contained in the tank. The second amount of solvent may be substantially less than the first amount of solvent. For example, the ratio of the second amount of solvent to original amount of slurry that the operation began with at 310 may be in the range of 0.2:1 to 0.5:1. The second amount of solvent and the settled abrasive grain may then be stirred or mixed by the stirrer or any other suitable mixing mechanism. Moreover the second amount of solvent may have a different chemical composition that the first composition. For example, the second amount of solvent may be water with a surfactant (e.g., a soap or soap-like substance, such as dishwashing soap) constituting less than 1% of the solvent.

The settled abrasive grain is then washed in block 650. Washing the settled abrasive grain can be accomplished in a variety of ways. In one embodiment, the settled abrasive grain is washed by being mixed with the second amount of solvent by the stirrer or other suitable mixing or mechanism. Once mixed, the second amount of solvent and the previously settled abrasive grain form a mixture. The mixture is then pumped through the ultrasonic agitator. The period of time may be a defined period, such as anywhere from less than five minutes to an hour or more. The abrasive grain begins to settle to the bottom portion of the tank while being ultrasonically agitated and may finish settling after the ultrasonic agitation has ceased. The second amount of solvent and any other liquids may then be removed, leaving the settled abrasive grain.

The washing process may be repeated multiple times according to one embodiment. For example, the washing process may be repeated from two to ten times in order to ensure that the settled abrasive grain is free from contaminants. In some embodiments, the mixture is heated as described above in between each washing cycle. In addition, after each washing cycle the mixture may be analyzed to determine its composition. The mixture may be analyzed using a particle-sizing apparatus (e.g., a Coulter counter or other light and/or laser scattering particle-size apparatus). The mixture may also be analyzed by drying it as described above and then analyzing it for the presence of metals and silicon by wet chemical analysis. For example, a gravimetric process may be utilized comprising weighing the dry, settled abrasive grain, etching the grain with an etchant (e.g., KOH), rinsing and then drying the settled abrasive grain, and then weighing the grain again. The difference in the respective weights of the settled abrasive grain indicates the amount of silicon or other metals that were digested by the acid in the etchant. Moreover, in other embodiments the settled abrasive grain may be further heated and gas chromatography performed on the off-gas to analyze its composition. A decision may then be made as to whether to wash the mixture again based on its composition. For example, if the mixture has a relatively high composition of abrasive grain (e.g., 80% to 95%), the mixture may not need to be washed again. Moreover, if the mixture is relatively free from contaminants, the mixture may not need to be washed again. Additionally, the final washing cycle may only utilize water as the solvent.

The settled abrasive grain is then heated in block 660. The heating of the settled abrasive grain may take place within the tank. As described above, heating elements may be integrated into the tank or disposed thereon or the exterior of the tank may be heated by a heat source (e.g., a burner or other suitable device). In other embodiments, the settled abrasive grain may be removed from the tank before being heated, or a removable tank bottom (e.g., a pan) may be removed from the tank and heated. Heating the settled abrasive grain dries and removes moisture therefrom. After drying of the grain it may be ground or otherwise broken up and reused in wire slicing operations. Accordingly, the method 600 enables the efficient separation of used abrasive grain from an oil-based wire-slicing slurry without the use of strong solvents.

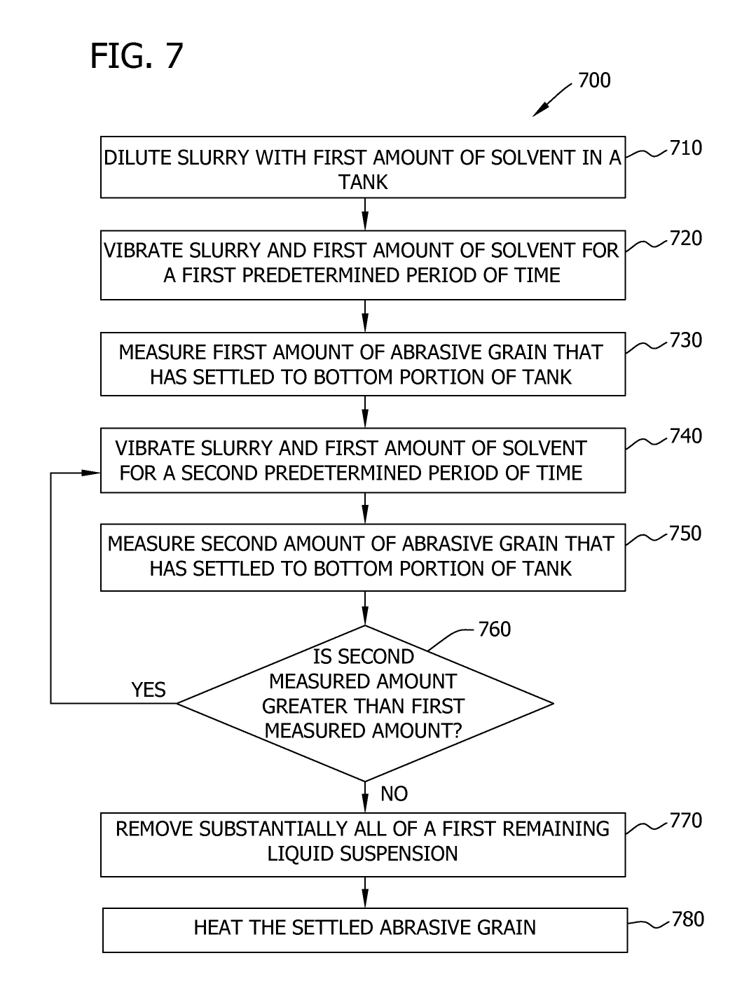

FIG. 7 is a flow diagram depicting a method 700 for recovering abrasive from a slurry. In the embodiment of FIG. 7, the slurry is an exhausted abrasive slurry used in a wire saw comprising an oil-based liquid suspension medium, abrasive grains or grit, fine particles of the material being cut (e.g., silicon), and metal particles abraded from the wire used in the wire saw.

The method 700 is operable with the system described above in relation to FIG. 1, but may also be used with other systems. The method 700 may also be used in conjunction with any of the methods 200, 300, 400 such that the slurry is subject to both vibration and ultrasonic agitation.

The method 700 begins in block 710 with diluting the slurry with a first amount of a solvent in the tank. The first amount of solvent is generally greater than the volume of slurry in the tank. As described above, the ratio of the first amount of solvent and the slurry is approximately 2:1, while in other embodiments the ratio may vary from 1:1 to 4:1.

After the first amount of solvent is added to the slurry, the two are together referred to as the “composition”. The composition is then vibrated in block 720 for a first predetermined period of time with the vibrators described above in relation to FIG. 1. Vibration of the composition results in the separation of the abrasive grain from the rest of the composition. Moreover, it is believed that the vibrations initiated in the composition by the vibrators cause the relatively large abrasive grains (when compared to the other particulates in the slurry) to separate from the other components of the slurry.

The first predetermined period of time is in the range of about 10-60 minutes in the embodiment of FIG. 7. In other embodiments, the predetermined period of time may be determined based on the amount of time required for a set amount (e.g., about 50%) of the abrasive to separate from the other components of the composition.

In block 730, a first amount of abrasive grain that has separated from the composition and settled to the bottom portion of the tank is measured. Vibration of the composition may cease while the measurement is taken, or vibration may continue while the measurement is taken. In the embodiment of FIG. 7, the measurement of the first amount of abrasive grain is conducted by measuring the depth of the abrasive grain that has settled in the bottom portion of the tank with a probe.

The slurry and first amount of slurry are then vibrated in block 740 for a second predetermined period of time. This second period of time may be substantially less than the first (e.g., between about 1-15 minutes). In block 750, a second amount of abrasive that has separated from the composition and settled to the bottom portion of the tank is measured. As in block 730, this measurement is conducted by measuring the depth of the abrasive grain that has settled in the bottom portion of the tank with a probe.

The two measured amounts are then compared against each other in block 760 to determine if the second measured amount is greater than the first measured amount. If the second measured amount is greater than the first measured amount, then additional abrasive grain settled to the bottom portion of the tank in block 750. In this case, it is likely that additional abrasive grain will settle to the bottom portion of the tank if the composition is further vibrated. Accordingly, if the second measured amount is greater than the first measured amount, the method 700 returns to block 740 for additional vibration. However, if the second measured amount is the same as the first measured amount or within a predetermined tolerance (e.g., 5%) it is unlikely that additional abrasive grain will settle to the bottom portion of the tank if the composition is further vibrated. In this case, the method 700 proceeds on to block 770.

The portion of the composition remaining after at least some of the abrasive grain has settled to the bottom portion of tank is referred to as a first remaining liquid suspension. In the embodiment of FIG. 7, substantially all of the first remaining liquid suspension is removed in block 770 from the tank. In some embodiments, the first remaining liquid suspension is removed from the tank by pumping, skimming, or draining therefrom after substantially all (e.g., greater than about 75%) of the abrasive grain has settled to the bottom portion of tank.

In some embodiments, an additional amount of first solvent may be added to the settled abrasive grain after the removal of the first remaining liquid suspension, and the steps described above are repeated. This process may occur a number of times (e.g., two to ten times) in order to remove additional liquid-suspension media from the abrasive grain. Additionally, these subsequent steps may utilize a different type of solvent than the first solvent. For example, the different type of solvent may be KOH, water, or acid (e.g., oxalic acid).

The settled abrasive grain is then heated in block 780. The heating of the settled abrasive grain may take place within the tank. A heater (e.g., heating elements) may be integrated into the tank or disposed thereon or the exterior of the tank may be heated by a heat source (e.g., a burner or other suitable device). In other embodiments the settled abrasive grain may be removed from the tank before being heated. Heating the settled abrasive grain dries and removes moisture therefrom. According to some embodiments, the settled abrasive grain may be heated for between 30 minutes and four hours at temperatures ranging from 100° C. to 250° C. The length of time may vary depending on the moisture content of the settled abrasive grain and how quickly it may be heated and then cooled after it has dried. The temperatures may range on the lower end from the boiling point of the solvent. Higher temperatures may be used to more quickly dry the settled abrasive grain. However, higher temperatures require greater amounts of heat and correspondingly incur an increased cost. After drying of the grain it may be ground or otherwise broken up and reused in wire slicing operations. Accordingly, the method 700 enables the efficient separation of used abrasive grain from oil-based wire-slicing slurry without the use of strong solvents.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawing[s] shall be interpreted as illustrative and not in a limiting sense.

What is claimed is:

1. A system for separating an abrasive from an oil-based slurry, the system comprising:
a substantially enclosed tank, the tank having an inlet for receiving an oil-based slurry and an outlet for removing at least a liquid suspension;
an ultrasonic agitator in fluid communication with the tank, the ultrasonic agitator operable to ultrasonically excite the oil-based slurry as it is pumped through the ultrasonic agitator; and
a back pressure regulator in fluid communication with the ultrasonic agitator and the tank, the back pressure regulator operable to regulate the pressure of the oil-based slurry as it flows through the ultrasonic agitator.

2. The system of claim 1 wherein the inlet of the tank is operable to receive an exhausted abrasive slurry used in a wire saw.

3. The system of claim 1 wherein the tank comprises a heater operable to heat abrasive separated from the oil-based slurry.

4. The system of claim 1 wherein the tank comprises a stirrer operable to stir the oil-based slurry inside of the tank.

5. The system of claim 4 wherein the stirrer comprises:
a shaft;
at least one vane coupled to the shaft; and
a drive source coupled to the shaft, the drive source operable to rotate the shaft.

6. The system of claim 1 wherein the tank comprises a vapor conservation port operable to selectively vent vapors from the tank.

7. The system of claim 1 further comprising a pump operable to pull the oil-based slurry from the tank and push the oil-based slurry into the ultrasonic agitator.

8. The system of claim 7 wherein the pump is at least one of a centrifugal pump, a progressive cavity pump, and a positive displacement pump.

9. The system of claim 1 wherein the back pressure regulator is operable to regulate the pressure of the oil-based slurry in the ultrasonic agitator such that the pressure of the oil-based slurry in the ultrasonic agitator is greater than an ambient pressure outside of the ultrasonic agitator.

10. The system of claim 1 wherein the back pressure regulator is operable to regulate the pressure of the oil-based slurry in the tank.

11. The system of claim 10 wherein the back pressure regulator is operable to regulate the pressure of the oil-based slurry in the tank such that the pressure of the oil-based slurry in the tank is greater than an ambient pressure outside of the tank.

12. The system of claim 1 wherein the ultrasonic agitator is positioned within the tank.

13. The system of claim 1 further comprising at least one vibrator positioned proximate the tank, the at least one vibrator operable to vibrate the oil-based slurry disposed in the tank.

14. The system of claim 13 wherein the at least one vibrator is operable to generate vibrations in a range of 10 hertz to 5 kilohertz.

15. The system of claim 13 wherein the at least one vibrator is operable to generate vibrations in a range of 15 hertz to 200 hertz.

16. The system of claim 13 wherein the at least one vibrator is operable to generate vibrations in a range of 20 hertz to 100 hertz.

17. The system of claim 13 wherein the at least one vibrator is coupled to an exterior of the tank.

18. The system of claim 13 wherein the at least one vibrator is coupled to an interior of the tank.

19. The system of claim 13 wherein the at least one vibrator comprises:
an eccentric weight; and
a drive source operable to rotate the eccentric weight.

20. The system of claim 13 further comprising a control system communicatively coupled to the at least one vibrator, the control system operable to control a vibration frequency of the at least one vibrator.
